(19) United States
(12) Patent Application Publication
(10) Pub. No.: US 2011/0076355 A1
(43) Pub. Date: Mar. 31, 2011

(54) Device for producing and filling containers

(76) Inventor: Bernd Hansen, Sulzbach-Laufen (DE)

(21) Appl. No.: 12/736,639

(22) PCT Filed: Jun. 10, 2009
(86) PCT No.: PCT/EP2009/004151

§ 371 Date: Oct. 26, 2010

(30) Foreign Application Priority Data
Jun. 17, 2008 (DE) 10 2008 028 754.7

(51) Int. Cl. B29C 49/48

(52) U.S. Cl. 425/524

(57) ABSTRACT

The invention relates to a device for producing and filling containers, in which at least one tube made of a plasticised material can be extruded in an open form (17). A filling device (9) comprising several individual functional channels (21, 39) enables at least the filling material to be introduced into the respective container by means of a filling mandrel (11) associated with a related form (17). Said device is characterized in that it comprises a mandrel cover (27) that has at least one functional space (31, 35), establishes a media-guiding connection between the respective functional space (31, 35) thereof and the respectively associated functional channel (21, 39) of the filling device (9) for cleaning and/or sterilizing and/or drying, in its functional position, and is removed from the functional position thereof during the production and filling of the container.

The invention relates to a device for producing and filling containers, in which at least one tube of plasticized plastic material can be extruded into an open mold, and by means of a filling device comprising several function channels which are separate from one another, at least the filling material can be delivered into the respective containers by means of a filling mandrel which is assigned to the pertinent mold.

In the pertinent prior art, a system which economically enables automated molding (blow molding or vacuum molding), filling, and sealing of containers is known under the trademark Bottelpack®. When the indicated containers are to be filled with highly sensitive products, for example, pharmaceuticals, the international standards for aseptic packaging must be satisfied. To do this, in the known solutions the mold, when it has been moved into the fill position, is under a so-called sterile filling space (ASR) in which sterile air flows via the open fill opening of the container and forms effective protection against the penetration of germs until movable mold parts are closed after completion of the filling process, in order to make the desired head closure of the container by a combined vacuum welding process. Such sterile filling spaces and their systems for sterile filling of containers are known in the prior art, for example, in the form of DE 196 48 087 A1 or U.S. Pat. No. 5,862,840.

Careful cleaning and sterilization both of the filling device with its function channels and also the parts interacting with it are carried out in rotation and definitely at the start of a production period as a further measure to ensure sterility during production which corresponds to Class 100 according to the international classification.

The object of the invention is to make available a device of the type under consideration in which cleaning and sterilization processes can be carried out especially easily and with an efficiency which has been improved relative to the art.

According to the invention, this object is achieved by a device which has the features of claim 1 in its entirety.

Accordingly, one particularity of the invention consists in that there is a mandrel protective cover which has at least one functional space, which in its function position produces a media-carrying connection for purposes of cleaning and/or sterilization and/or drying between its respective functional space and the respectively assignable function channel of the filling device, and which during container production and filling is moved out of its function position. This makes it possible to deliver those media into the functional space or spaces within the protective cover which are suitable for cleaning, sterilization, cooling/drying, etc., via a respective function channel of the filling device. In other words, the protective cover forms a component of a cleaning, sterilizing, and/or drier means which can be operated via the corresponding media supply from the filling device in order to bring the device into an aseptic state for starting the production interval.

In constructions of the device which are designed for efficient production, at least one filling mandrel can be set into the selected operating positions by longitudinal displacement, and in the operating position which interacts with the protective cover is accommodated with a longitudinal section in at least one functional space of the protective cover which is in the function position. In this way the medium intended for the cleaning, sterilization, or drying/cooling process which is to be carried out can be delivered into the pertinent space within the protective cover directly via the pertinent function channels which run within or along the respective filling mandrel. In this way, not only are cleaning, sterilizing, and drying of the function channels of the system through which the media are flowing accomplished, but the corresponding media also act on the outside surface of the filling mandrel which is located in the functional space of the protective cover, so that the processes of cleaning, sterilization, and drying also act on the outside surface of the respective sections of the filling mandrel which are held in the protective cover.

In especially advantageous exemplary embodiments, the protective cover has a first and a second functional space which are offset to one another in the direction of longitudinal displacement of the respective filling mandrel, and of which the first accommodates that end section of the respective filling mandrel on which is located the outlet of the function channel which runs centrally in the filling mandrel and which is used as the filling channel during filling. Therefore, the end section of the filling mandrel is directly flushed by the media which are flowing out of the filling material outlet and through the filling channel, so that in the creation of the aseptic state of the filling channel itself at the same time the outside of the end section of the respective filling mandrel is treated.

Preferably, the second functional space of the protective cover is designed to house the longitudinal section of the respective filling mandrel which is connected to the end section, and has an input opening through which in the corresponding operating position and in the function position of the protective cover the respective filling mandrel extends and via which the connection between the second functional space and another function channel of the filling device can be established. Such channels can be provided, for example, for the supply of sterile air which is used as support air in the process of tube formation, or as a supply channel for cooling media. Because a connection is established between the longitudinal section of the filling mandrel which is accommodated in the second functional space of the protective cover and at least one such media supply channel, the supply of cleaning, sterilizing, and drying media leads not only to the corresponding treatment of media supply channels, but acts in turn on the outer side of the pertinent filling mandrel which is held in the second functional space of the protective cover.

In designs in which the respective filling mandrel extends through an extruder head which preferably has an elongated construction with tube-forming extruder outlet nozzles which are arranged in a row and to which nozzles a respective row of filling mandrels are assigned, said extruder head preferably has a face which is adjoined flat by the cover wall of the protective cover in its function position, which wall has the input opening of the respective second functional space. In especially advantageous exemplary embodiments, the arrangement is such that the other function channel extends along the outer side of the filling mandrel through the extruder head and ends on its face, such that by way of the input opening in the adjoining cover wall of the protective cover the connection to its second functional space is formed, specifically by the other function channel continuing along the outer side of the filling mandrel through the input opening into the interior of the protective cover.

Preferably, each functional space of the protective cover has a media output via which the respective media which are supplied by the connection to the function channels of the filling device, for example, cleaning and/or sterilization media and/or cooling/drying media, can be discharged to the outside.

In advantageous exemplary embodiments, the arrangement can be made such that the protective cover forms a protective body whose respective input opening is adjoined by the second functional space which is separated from the coaxially following first functional space by a seal insert which forms a central passage for the entry of the filling needle-like end section of the filling mandrel which forms the outlet for the filling material into the first functional space.

The protective cover can be arranged to be able to move by displacing its cover wall along the face of the extruder head into and out of the function position; this enables a simple construction by only one linear drive for a displacement motion of the protective cover being necessary.

In embodiments which are characterized by an especially compact structure, the filling device, in addition to the dosing system assigned to the central filling material channel of the respective filling mandrel, also has supply devices by which both the filling material channel and also the other function channels can be alternately supplied with the desired treatment and/or working media, that is, for example, with cleaning media, sterilizing media, drying media, or cooling media.

In especially advantageous exemplary embodiments, at least one function channel which runs outside the filling mandrel along its outer side can be supplied with a sterile, gaseous medium which in the course of the extrusion process which forms the tube can be discharged on the face of the extruder head and which on the inside of the tube is used as support air which stabilizes the tube. In this way, not only is collapse of the tube prevented prior to the molding process of the container, but also sterile air forms a sterile space in the interior of the tube. More accurately, the interior of the tube and the mold, when it is moved into the filling position, are in a so-called sterile filling space (ASR) in which sterile air flows via the open fill opening of the respective container and forms effective protection against the penetration of germs until the movable head jaws of the mold are closed after completion of the filling process in order to form the desired head closure of the container by a combined vacuum welding process.

The invention is detailed below using one exemplary embodiment shown in the drawings.

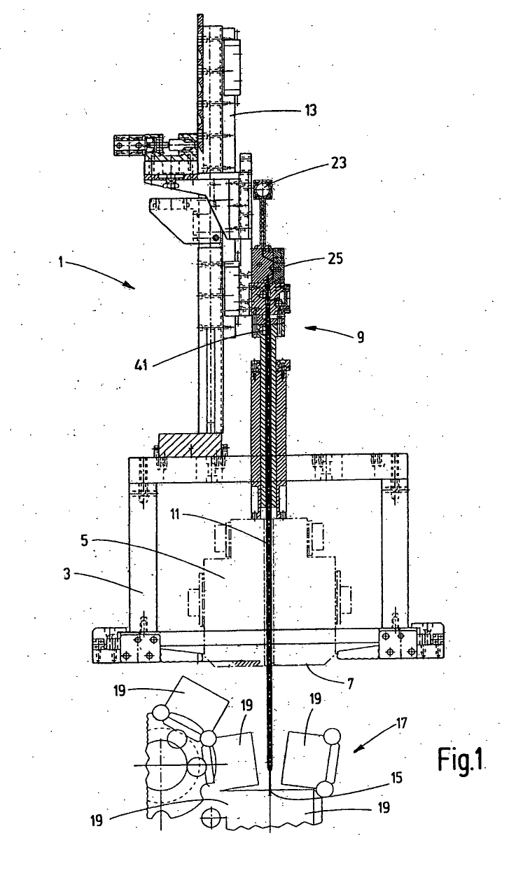

FIG. 1 shows a highly schematically simplified and partially vertically cutaway overall representation of one exemplary embodiment of the production device according to the invention, the operating state within the production process being shown in which the single visible filling mandrel with its filling needle-like end extends into the mold with movable mold parts;

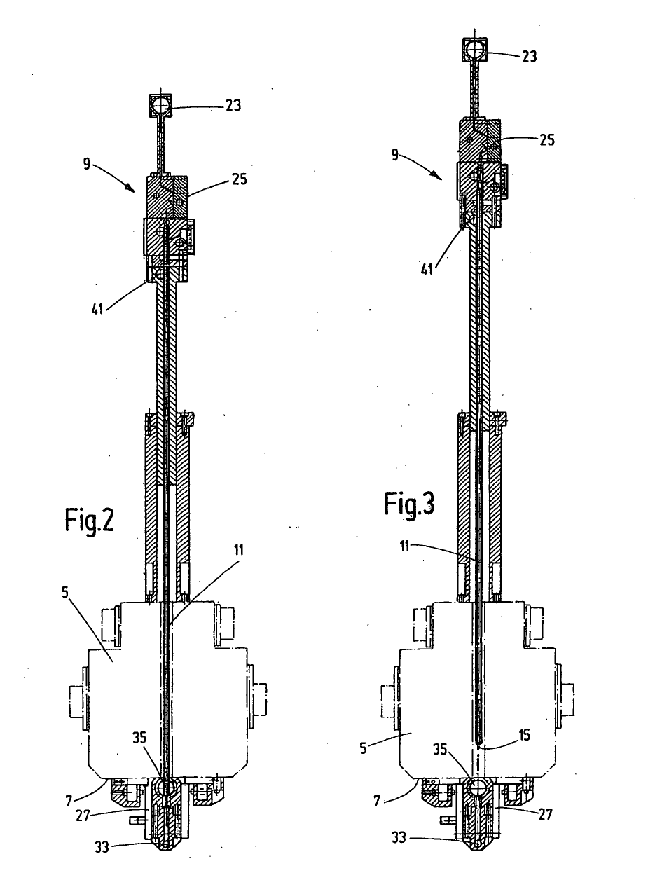

FIG. 2 shows a representation of only the extruder head and the filling mandrel with the pertinent filling device, slightly enlarged compared to FIG. 1 and partially in a vertical section, the filling mandrel being shown in the operating position in which it is held with a longitudinal section in the protective cover which is in its function position on the face of the extruder head;

FIG. 3 shows a representation corresponding to FIG. 2, where the filling mandrel, however, is withdrawn into the operating position into the extruder head, and the protective cover can be moved out of its function position;

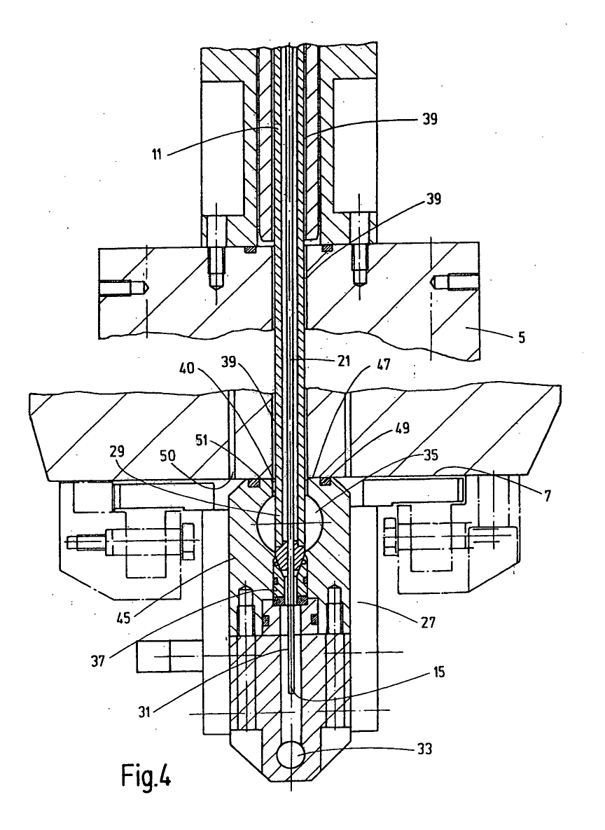

FIG. 4 shows a vertical partial section, highly enlarged relative to FIGS. 2 and 3 and partially broken away, the operating and function positions shown in FIG. 2 being illustrated, and

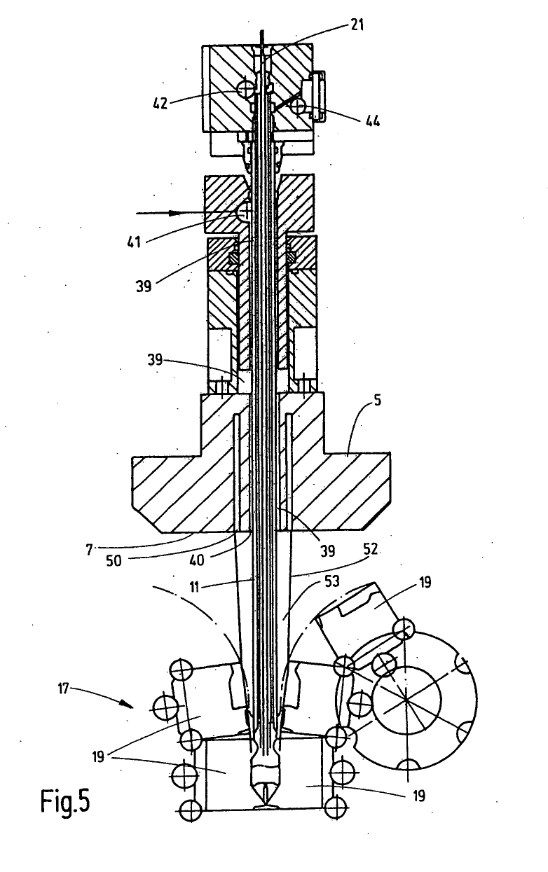

FIG. 5 shows a schematically simplified vertical section in which in FIG. 1 the filling position of the single visible filling mandrel is shown and a sterile space which extends within the tube along its outer side between the extruder head and mold is illustrated.

In FIG. 1 a device frame is designated as a whole as 1. On its base frame 3 an extruder head 5 is mounted which in such devices, as is conventional, has at least one extrusion nozzle (50 in FIGS. 4 and 5), from which in operation a tube (52 in FIG. 5) emerges which is formed from the plasticized plastic material which has been supplied to the extruder head 5 on a face 7 of the extruder head 5. Since such extruder devices, for example, in the form of devices operated according to the Bottelpack® process, are inherently known, further explanation of the details of the extruder head 5 is unnecessary. Let it be simply noted that there is a filling device 9 with at least one filling mandrel 11 which extends in the extruder head 5 in the longitudinal direction. While in the figures only one filling device 9 with a filling mandrel 11 is shown at a time, it goes without saying that the extruder head 5 is preferably elongated in the direction perpendicular to the plane of the drawing, and that there can be a plurality of filling devices 9 located in a row perpendicular to the plane of the drawing with filling mandrels 11.

In the manner which is conventional for such devices, the respective filling mandrel 11 can be moved in the longitudinal direction into various chosen operating positions, for example, such that with its filling device 9 it is movably supported on the frame carrier 13. In any case, the filling mandrels 11 can be set clock-controlled into the operating positions which are necessary for the production and filling process and for cleaning, sterilization, and drying.

FIGS. 1 and 5 show the filling mandrel 11 in the advanced operating position for a filling process, the end section 15, which is tapered in the shape of a filling needle, being advanced into a mold 17 which is not yet closed on the head side. In the manner of a revolver arrangement, individual mold parts 19 are moved in pairs toward one another on an imaginary arc path in order to form a closed production mold, and are moved apart again for opening of the mold. For dosed delivery of the filling material from the end section 15, each filling mandrel 11 has a centrally located function channel in the form of a filling channel designated as 21 in FIGS. 4 and 5. From a central filling material line 23, controllable dosing units 25 of each filling device 9 can be delivered with the product to be added. The dosing units 25 deliver the dosed amounts which are required for each filling process clock-controlled to the pertinent filling channel 21.

In contrast to FIGS. 1 and 5, FIGS. 2 to 4 show the operating positions which the pertinent filling mandrel 11 assumes, while preparatory measures are carried out before production is started. In this respect, FIGS. 2 and 4 show one operating position in which the filling mandrel 11 which has been withdrawn from the region of the mold 17 is held with a longitudinal region within a protective cover 27. As FIG. 4 best illustrates, it is the fill needle-like end section 15 with the filling material outlet and a longitudinal section 29 which is connected to it (FIG. 4). The end section 15 is in a first functional space 31 within the protective cover 27, an output channel 33 forming a media outlet from the space 31. The longitudinal section 29 which is connected to the end section 15 is held in the protective cover 27 in a second functional space 35 from which likewise an output channel (not shown) enables discharge of the media to the outside. The spaces 31 and 35 are separated from one another by a seal insert 37 through which the fill needle-like end section 15 extends into the first space 31 when the filling mandrel 11 assumes the operating position shown in FIGS. 2 and 4. Besides the function channels which run conventionally in the filling mandrel 11 in such devices, like the central filling channel 21, there is at least one other function channel which is used as a feed channel for the media, as is detailed only in FIGS. 4 and 5, where this channel is designated as 39. This other function channel 39 extends along the outer side of the pertinent filling mandrels 11, as is apparent from FIGS. 4 and 5, proceeding from an inflow supply connection 41 (FIG. 5), continuing as far as to an outlet mouth 40 on the face 7 of the extruder head 5. Connections intended for additional function channels which may be present, for example, for the mandrel cooling input and mandrel cooling outlet, are designated as 42 and 44 in FIG. 5.

In the operating state shown in FIGS. 2 and 4, the cover body 45 of the protective cover 27 with its cover wall 47 adjoins the face 7 of the extruder head 5 flat. Here the edge of the input opening 51 in the cover wall 47 of the cover body 45 is aligned to the mouth 40 of the function channel 39 so that the function channel 39 continues into the interior of the second functional space 35 via the input opening 51. At the same time, the first functional space 31 of the protective cover 27 is connected to the filling channel 21 by way of the filling material opening on the end section 15.

In the state shown in FIGS. 2 and 4, the cover body 45 of the protective cover 27 with its cover wall 47 adjoins the face 7 of the extruder head 5 flat within the edge of the pertinent extrusion nozzle opening 50, relative to which it is sealed by a seal arrangement 49 which is held in the cover wall 47. Within the seal arrangement 49, the cover wall 47 of the body 45 has an input opening 51 through which the longitudinal section 29 of the filling mandrel 11 extends into the protective cover 27. The size of the entry opening 51 is dimensioned such that the mouth 40 of the media supply channel 39 on the edge of the entry opening 51 is connected to the second functional space 35 in the protective cover 27. At the same time, the first functional space 31 of the protective cover 27 is connected to the filling channel 21 on the end section 15 by way of the filling material opening.

In this operating state, all the measures associated with cleaning and sterilizing can be carried out via the connection between the channels 21, 39 of the filling mandrel 11 with the spaces 31 and 35 of the protective cover 27. In this respect, it is possible to proceed such that by way of the supply connection 23 and the dosing system 25 which is switched into the throughflow state, cleaning liquid which cleans the filling channel 21 is delivered into the functional space 31 from which the liquid emerges via the channel 33. By way of the connection between the media supply channel 39 and the second functional space 35, from the supply connection 41 of the filling device 9 further supply of media is possible, as a result of which the longitudinal section 29 of the filling mandrel 11 is cleaned or sterilized on the peripheral side. In the same operating position of the filling mandrel 11 and when the protective cover 27 is in the function position, following the cleaning of the filling channel 21, the sterilization process can be initiated by superheated steam of at least 121° C. flowing in by way of the filling device 9 via the filling channel 21 and sterilizing not only the inside of the filling channel 21, but also the outer side of the end section 15 within the space 31 of the protective cover 27. In the corresponding manner, sterilizing superheated steam can be delivered into the space 35 of the protective cover 27 via the media supply channel 39 so that the outside of the section 29 is sterilized as well.

In the manner which is conventional in cleaning and sterilizing processes, the corresponding drying/cooling processes can then be carried out via the same media connections, the condensate of the preceding sterilizing steam being blown out by supplying sterile air.

Subsequent to the drying, the pertinent filling mandrel 11 is withdrawn into the operating position shown in FIG. 3, so that the protective cover 27 is moved out of the function position shown in FIGS. 2 to 4, the protective cover 27, for example, being pushed in the direction perpendicular to the plane of the drawing on the face 7 of the extruder head 5.

After moving the protective cover 27 out of the function position, the device is ready for the start of a production interval. Because the mouth 40 of the function channel 39 running along the outside of the filling mandrel 11 during the production phase shown in FIGS. 1 and 5 is located within the tube 52 (FIG. 5) which is emerging from the extrusion nozzle opening 50, the medium which is supplied via the function channel 39 flows into the interior of the tube 52. The latter, in its path from the extruder head 5 into the mold 17, thus forms a closed space. When sterile air flows in via the function channel 39, a sterile filling space 53 is formed within which the entire production process is carried out, i.e., up to formation of the head closure on the filled container; this is done by closing the pertinent head jaws of the mold 17. Since the corresponding mechanisms of the mold are known, in the drawings the mold which is designated as a whole as 17 is schematically simplified, therefore without a separate representation of the primary mold parts and head mold parts. The execution according to the invention therefore yields not only stabilization of the tube by means of the supplied support air via the outlet mouth 40, but also, by sterile air being blow in, the formation of a sterile zone so that the device satisfies international standards with respect to asepsis (Class 100) to a special degree.

1. A device for producing and filling containers, in which at least one tube of plasticized plastic material can be extruded into an open mold (17), and by means of a filling device (9) comprising several function channels (21, 39) which are separate from one another, at least the filling material can be delivered into the respective containers by means of a filling mandrel (11) which is assigned to the pertinent mold (17), characterized in that there is a mandrel protective cover (27) which
has at least one functional space (31, 35),
in its function position produces a media-carrying connection for purposes of cleaning and/or sterilizing and/or drying between its respective functional space (31, 35) and the respectively assignable function channel (21, 39) of the filling device (9), and
during container production and filling is moved out of its function position.

2. The device according to claim 1, characterized in that at least one filling mandrel (11) can be set into selected operating positions by longitudinal displacement and, in the operating position which interacts with the protective cover (27), is accommodated with a longitudinal section (15, 29) in at least one functional space (31, 35) of the protective cover (27) which is in the function position.

3. The device according to claim 2, characterized in that the protective cover (27) has a first (31) and a second functional space (35) which are offset to one another in the direction of longitudinal displacement of the respective filling mandrel (11), and of which the first (31) holds that end section (15) of the respective filling mandrel (11) on which is located the outlet of the function channel which runs centrally in the filling mandrel (11) and which is used as the filling channel (21) during filling.

4. The device according to claim 3, characterized in that the second functional space (35) of the protective cover (27) is designed to house the longitudinal section (29) of the respective filling mandrel (11) which is connected to the end section (15) and has an input opening (51) through which in the corresponding operating position and in the function position of the protective cover (27) the respective filling mandrel (11) extends and via which the connection between the second functional space (35) and another function channel (39) of the filling device (9) can be established.

5. The device according to claim 4, characterized in that the respective filling mandrel (11) extends through an extruder head (5) which has a face (7) which is adjoined flat by the cover wall (47) of the protective cover (27) in its function position, which wall has the input opening (51) of the respective second functional space (35), and that the other function channel (39) extends along the outer side of the filling mandrel (11) through the extruder head (5) and ends on its face (7) such that by way of the input opening (51) in the adjoining cover wall (47) of the protective cover (27) the connection to its second functional space (35) is formed.

6. The device according to claim 1, characterized in that each functional space (31, 35) of the protective cover (27) has a media output (33) via which the respective media supplied by the connection to the function channels (21, 39) of the filling device (9), for example, cleaning and/or sterilizing media and/or cooling/drying media, can be discharged to the outside.

7. The device according to claim 6, characterized in that the protective cover (27) forms a protective body (45) whose respective input opening (51) is adjoined by the second functional space (35) which is separated from the coaxially following first functional space (31) by a seal insert (37) which forms a central passage for the entry of the filling needle-like end section (15) of the filling mandrel (11) which forms the outlet for the filling material into the first functional space (31).

8. The device according to claim 7, characterized in that the protective cover (27) can be moved by displacing its cover wall (47) along the face (7) of the extruder head (5) into and out of the function position.

9. The device according to claim 1, characterized in that the filling device (9) in addition to the dosing system (25) assigned to the central filling material channel of the respective filling mandrel also has supply devices (23, 41) by which both the filling material channel (21) and also the other function channels (39) can be alternately supplied with cleaning media, sterilizing media, drying media, or cooling media.

10. The device according to claim 9, characterized in that at least one function channel (39) which is located outside the filling mandrel (11) and which forms a flow path which is routed along the outer side of the filling mandrel (11) can be supplied with a sterile, gaseous medium which in the course of the extrusion process forming the tube (52) can be discharged on the face (7) of the extruder head (5) and which on the inside of the tube is used both as support air which stabilizes the tube (52) and also forms a sterile zone in it.
